(19) United States
(12) Patent Application Publication
(10) Pub. No.: US 2018/0220499 A1
(43) Pub. Date: Aug. 2, 2018

(54) RADIO FREQUENCY HEATING SYSTEM

(71) Applicant: C-TECH INNOVATION LIMITED, Capenhurst, Cheshire (GB)

(72) Inventors: Michael SIMS, Capenhurst, Cheshire (GB); Brian GREEN, Capenhurst, Cheshire (GB)

(21) Appl. No.: 15/746,655

(22) PCT Filed: Jul. 13, 2016
(86) PCT No.: PCT/GB2016/052108

§ 371 Date: Jan. 22, 2018

(30) Foreign Application Priority Data
Jul. 24, 2015 (GB) 1513120.4

(51) Int. Cl. H05B 6/68; H05B 6/50; H05B 6/66; H05B 6/70

(52) U.S. Cl. CPC H05B 6/686; H05B 6/50; H05B 2206/043; H05B 6/705; H05B 6/666

(57) ABSTRACT

A radio frequency heating system having a radio frequency amplifier supplying power to a radio frequency heating chamber and a matching network includes a controller monitoring forward and reflected power, phase and amplitude of the power supply to the heating chamber and adjusting the power supplied by the radio frequency amplifier and/or the impedance of the matching network in accordance with predetermined values of the reflected power, and/or phase and amplitude.

### TECHNICAL FIELD

This invention relates to a radio-frequency heating system for heating materials, in particular, but not exclusively foodstuffs.

### BACKGROUND ART

Radio-frequency radiation is in common use as an industrial means of heating materials including foodstuffs. Uses include drying of wood, paper, textiles, and the defrosting of frozen food-stuffs including meat, fish, and dairy products. Radio-frequency heating is a form of dielectric heating, in common with microwave heating. This form of heating has advantages over conventional heating methods including conductive heating because the body of the material is heated directly, without the need for hot surfaces and consequent temperature gradients. It significantly reduces the potential for unwanted overheating or burning of external surfaces and the risk of only partial heating of internal parts of material being heated. Radio-frequency heating has advantages over microwave heating because of the longer wavelengths used, which allows larger objects to be heated more evenly. This make RF heating ideally suited for defrosting and other applications where even heating and the avoidance of local hotspots are required. The invention allows for smaller size of radio-frequency heaters up to, say, 2 kW power.

Radio-frequency heating apparatus must contain the following essential components. First, a power source (amplifier) to produce an electrical signal at a particular frequency. The frequency can be between 5 MHz and 300 MHz and might be fixed or variable but it is more usually one of the International Scientific and Medical (ISM) bands set by international agreement and including bands suitable for use in heating apparatus centred at 13.560 MHz, 27.120 MHz, and 40.680 MHz Secondly a heating chamber is necessary comprising of two electrodes, one being typically earthed, the other live. Radio-frequency power is applied between the two electrodes. The product or item to be heated is placed between the two electrodes. Lastly a means of matching the impedance of the power source to the impedance of the load is required, commonly referred to as a “matching network”. The power source and load each constitute a resonant electrical circuit, and the resonant properties of the load circuit depend on both the physical nature of the material to be heated as well as the fabric of the electrical circuit. Since the material being heated is of variable composition and electrical impedance it is necessary to match the impedances of the two circuits so that power can be effectively transferred from source (amplifier) to load (item to be heated). If this condition is not met then a greater or lesser proportion of power is reflected from the load circuit to the amplifier. This results in inefficient heating of the product with corresponding heat generation in the circuits of the power source. At best this is an inefficient use of power and at worst it can lead to the source or amplifier circuit becoming overloaded and failing. Many different designs of matching networks are known and used and this invention may be applied to any of them.

When heating substances, it is invariably the case that the electrical impedances of different samples or batches are different, arising from differences in composition or physical dimensions or both. It is invariably the case that the electrical impedance of a material will change as it is heated as a result of changes in composition or temperature dependent properties. It is necessary therefore that a radio-frequency heating device either has an amplifier supply which is robust to some level of reflected power, or which has its impedance matched to that of the load, or some combination of both.

Impedance matching networks are commonly used in radio-frequency heating devices for the reasons mentioned above. These matching networks include capacitances and inductances with variable components in order to achieve the desired impedance phase and magnitude. Variable capacitors are preferred over variable inductances since these are easier to fabricate. Variable capacitors can be of the rotary vane type, vacuum type, or combinations of fixed value capacitors which are switched in and out of circuit, with or without the use of additional solid-state variable capacitors, or any other suitable capacitor type. It is common practice to use a radio frequency amplifier with fixed impedance, typically 50 or 75 ohms. These are industry standards and indicate that the amplifier has a purely resistive impedance of this value. In this case the matching network needs to match the impedance of the load to this restive 50 or 75 ohms value. It does this by detecting and adjusting the phase angle and magnitude of the impedance of the load and adjusting it so that phase angle is zero, and the impedance of the load is purely resistive 50 (or 75) ohms and therefore matched to the amplifier. The problem with this method is that while control systems search for this condition by varying the values of variable capacitances in the circuit there exists the likelihood that there will be a mismatch between impedances of amplifier and load which will cause a significant part of the output of the amplifier to be reflected from the load and be dissipated in the amplifier. This can cause adverse effects including unwanted electrical transients, heating and consequent failure the amplifier. In order to prevent this from happening it is necessary that the radio frequency power supply control systems includes additional means of preventing the circuits from being overloaded with reflected power and or the radio frequency power supply circuits are specified to be able to cope with the reflected power and unwanted transients and other effects.

Taken together these requirements mean that radio-frequency heating systems are not suitable for small scale and low power applications, because the additional componentry and control systems required outweigh the advantages compared with other technologies. For defrosting applications other technologies such as warm air heating or microwave heating are commonly used. Compared with radio-frequency heating these technologies are less effective however. In the case of rack drying using circulating air the defrosting time for food-stuffs is typically several hours, often overnight. In the case of microwave defrosting there is an increased risk of local hotspots and cold-spots compared with radio frequency defrosting.

### DISCLOSURE OF INVENTION

According to one aspect of the present invention a radio frequency heating system including a radio frequency amplifier supplying power to a radio frequency heating chamber and a matching network includes a controller monitoring forward and reflected power, phase and magnitude in the power to the heating chamber and adjusting the power supplied by the radio frequency amplifier and/or the impedance of the matching network in accordance with predetermined values of the reflected power, and/or phase and amplitude.

The invention provides a matching circuit in such a way that the advantages of radio-frequency heating and defrosting can be achieved but without the disadvantage of needing additional control circuits and/or highly specified power supply components able to withstand significant reflected powers. The invention avoids the need for additional protection circuits or amplifier components specified to be capable of dissipating significant amounts of reflected power. The invention thus allows components of reduced size and specification in terms of heat dissipating capability to be used and therefore allows for a smaller size of radio-frequency heating unit.

The invention is suitable for radio-frequency heating systems of between 500 and 1500 watts—as well as large systems. Typical applications would be small heating systems having a power of 750 watts or less.

### BRIEF DESCRIPTION OF DRAWINGS

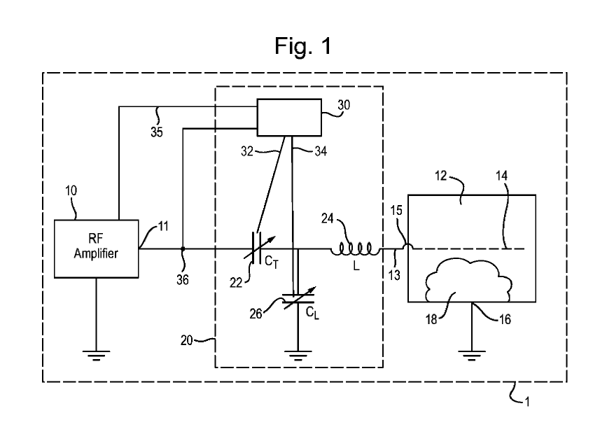

An example of the invention will now be described with reference to the attached FIG. 1 which shows a radio frequency heating system acceding to the invention.

### DESCRIPTION OF EXAMPLES OF INVENTION

In the FIGURE a radio frequency heating system 1 comprises an earthed frequency amplifier power source 10 having a power output 11, a heating chamber 12, with a power input 13 and having two electrodes 14 and 16, one electrode 16 being earthed and the other electrode 14. The FIGURE shows food 18 to be heated between the live electrode 14 and the earthed electrode 16.

A network matching circuit 20 is associated with the radio frequency amplifier power source. In conventional systems the network watching circuit comprises a capacitor (known as the tune capacitor) 22 and inductor 24 in line between the co-axial output cable 11 of power amplifier 10 and coaxial input cable of input 13 of the heating chamber 12. Between the capacitor and the inductor, a further capacitor (known as the load capacitor) 26 is connected to earth.

In conventional radio frequency heating systems of this type the control system will search for an impedance match between load and source by adjusting the values of capacitors 22 and 26 (or other components in another design of matching network). Once the impedance condition is achieved then the power output of the amplifier will be increased at a predetermined rate. If the reflected power exceeds a certain limit then the power will be held at a certain level or returned to a predetermined lower level until impedance matching is attained once again. The disadvantage of this approach is that the power source must be robust to the anticipated instances of reflected power and or that the system may take longer to attain full power.

To overcome the issues of ill-matching of the impedances of source and load the present invention uses a controller 30, typically a proportional-integral-derivative controller (PID controller) into which is coded an adjusting algorithm. The controller 30 has control outputs, 32 adjusting the value of tuning capacitor 22, 34 adjusting the value of load capacitor 26 and 35 adjusting the power output of radio frequency amplifier 10. A power meter 36 consists of phase and magnitude detectors and measures the power output from the radio frequency amplifier 10 and the reflected power from the heating chamber 12, passing these measurements to controller 30. The reflected power measurement is used to control both the power output of the radio frequency amplifier 10 and the values of tune and load capacitors 22 and 26 as discussed below.

Control is exercised in four steps.

Initially in the first step, when the radio frequency amplifier 10 commences operation and begins to apply radio-frequency power to the heating chamber 12, the power applied from the amplifier increases from zero to a pre-determined value between 2% and 6% of the full radio-frequency output power of the radio frequency amplifier 10. The rate of increase is around 10 watts per second. The phase angle and magnitude of the complex impedance is detected and the values of both the tune capacitor 22 and load capacitor 26 in the matching network 20 are adjusted towards zero impedance phase angle by means of the proportional-integral-derivative controller 30. The algorithm adjusts the capacitors 22 and 26 in the matching network 20 at a maximum rate of 20% of their full value per second. The capacitors 22 and 26 are adjusted by the PID-controller until the reflected power is less than around 1 W, corresponding to impedance phase close to zero.

The purpose of Step 1 is to establish as quickly as possible the conditions for impedance matching at a low power rating. The rapid adjustment of capacitances in the matching network means that there is a possibility that a high percentage of the applied radio-frequency power will be reflected from the load circuit to the source as the unit varies the capacitances and searches for an impedance match. Damage to the amplifier circuit is prevented by limiting the applied power in this step to between 2% to 6% of the full rated power output, and the reflected power to around 25 W. The exact FIGURE on the limit of reflected power in this step is chosen with reference to the hardware limit on the amplifier.

Once a fixed time has elapsed from the switch on of power to the radio frequency amplifier, control moves to step 2 and the power output from the radio-frequency amplifier is increased more rapidly to a pre-determined level, say, around 100 watts per second. The upper limit of power applied in Step 2 is determined by the ability of the control algorithm to keep the reflected power below 10 W as it continues to adjust the values of the capacitance in the circuit. 10 W is less than the hardware limit of the amplifier for reflected power and gives a margin of error that allows the algorithm to operate in its less damped mode (that is it makes relatively more rapid adjustments to the capacitor values). If the reflected power does at any point exceed this 10 W value then the controller 30 prevents further power increase and the power is held at that level and the system adjusts the capacitances according to the same protocol described in step 1 above. When the reflected power falls to a predetermined level less than 10 W then the power increase is recommenced.

The purpose of Step 2 is to start from the impedance-matched condition at low power found in Step 1, and then increase the applied power up to a level of 20% or so of the full rated output in as short a period of time as possible but without allowing the reflected power to exceed safe limits for the components.

Beyond 20% of the full rated power output is achieved control moves to step 3, the applied power is increased further up to the full rated power output of the amplifier. In step 3, adjustment of the capacitances in the matching network takes place more slowly than in steps 1 and 2, typically around 0.1% to 0.2% of the full capacitance value per second. This ensures that the system retains its impedance-matched condition and the reflected power does not exceed safe limits for the amplifier circuit. The rate of power increase is typically around 100 watts per second. The network matching response is more damped in step 3 than it is in steps 1 and 2. If at any point the reflected power exceeds the pre-set value as described in step 2, then the power increase stops and the unit is allowed time to re-attain the matched network condition.

The purpose of step 3 is to reach the full set-point power as quickly as possible but without allowing the reflected power to exceed a pre-determined value. The limit of reflected power in steps 2 and 3 is less than in steps 1 and 4 (step 4 is discussed below). This is because the limit in steps 1 and 4 is determined by the allowable hardware limit, that is the maximum reflected power that the amplifier circuit will tolerate, whereas in steps 2 and 3 the limit is set lower so that the control algorithm can allow a faster rate of increase of applied power without creating a condition where the hardware limit on reflected power is reached.

Once the full power set-point is reached (which is either the full power of the radio frequency amplifier 10 or some lesser value selected by the user) then control moves to step 4 when the power is held constant and the impedance matching condition maintained using the damped-network matching algorithm as applied in step 3. The limit on reflected power is increased to around 25 W, as in Step 1, and as determined by the limits on the amplifier hardware.

The limits on reflected power are lower in steps 2 and 3 than they are in steps 1 and 4. Step I is at low power but without impedance matching having been achieved and step 4 is at full power but with impedance matching condition met. Steps 2 and 3 are transitional, with power increasing and the damping of the control system changing. The overall effect is to allow the fastest application of full power without exceeding the limits on reflected power.

A summary of the control steps are set out in the table below:

TABLE 1

| | | Rate of change | | |
|---|---|---|---|---|
| | Power | of capacitances | | |
| | applied as a | in the matching | Rate of | |
| | percentage | network as a | increase of | |
| | of full | percentage of the | applied | |
| | operating | value of the var- | power | Limit on |
| | power (set | iable capacitances | (watts per | reflected |
| | point power) | in the circuit | second | power |
| Step l | From 0 to | Up to 50 | 5 to 25 | 50 watts or |
| | 10 | | | the limit of |
| | | | | the radio |
| | | | | frequency |
| | | | | amplifier |
| | | | | whichever |
| | | | | is less |
| Step 2 | From 5 to | Up to 50 | Up to 500 | 20 watts |
| | 50 | | | |
| Step 3 | From 10 to | Up to 10 | Up to 500 | 20 watts |
| | 100 | | | |

### Example—A 500 Watt Radio Frequency Defroster

The system is a table top radio frequency heating system 1 (ISM frequency 27.12 MHz, 0-500 watts output) is used to defrost foods of various types. The heating chamber 12 is around 600 mm wide, 500 mm tall and 715 mm deep. The structure of the heating chamber 12 is mainly of 304 stainless steel construction, weighing around 40 kg. It has a touch screen display that allows the operator to select a pre-configured program to defrost various different food types. The controller 30 controls the radio frequency power delivered during the program using the radio frequency amplifier matching network 20 using signals from the sensor 36. The phase and magnitude signals are used to change the position of the tune and load variable capacitors 22 and 26 respectively in FIG. 1 in matching network 20 to match the impedance of food in the heating chamber 12 applicator to the radio frequency amplifier impedance of 50Q. The matching network of FIG. 1 is one of many designs equally applicable to use with the present invention.

The controller 30 first matches impedances and increases the power up to the rated power of 500 W (or other lower set-point) according to the algorithm described herein.

The heating system 1 contains a variable amplitude radio frequency amplifier 10 to provide the power supply of 500 W at 27.12 MHz. The power supply required is 50V DC @ 20 A. A low pass filter is included: this is a 5th order Butterworth π filter (not shown) that removes the harmonic frequencies above 27.12 MHz from the output of the radio frequency amplifier. A power meter 36 monitors the radio frequency high power signal and indicates the forward (0-500 W) and reflected (0-50 W) power levels using 0-5V analogue signals. It detects the phase difference between voltage and current and the magnitude ratio of voltage and current. The phase and magnitude levels are indicated using −5V to +5V analogue signals.

The controller 30 is used to match the impedance of the load circuit, including the food or other material to be heated, to the radio frequency amplifier output impedance of 50Q. It does this by means of the variable tune and load capacitors 22 and 26, and an inductance coil 24 in a “T” network configuration as shown in FIG. 1. Variable tune and load capacitors 22 and 26 were adjusted using servomotors driven using pulse width modulation signals from the controller 30.

Food is placed in the heating chamber 12 through a door sealed, to radio frequency waves, on the front of the system. The heating chamber 12 had of a top electrode 14 supported by insulated supports. The earthed electrode 16 is the metal base sheet of the applicator onto which the container of food is placed. The matching network 20 is connected to the heating chamber 12 using a copper conductor which is insulated from the rear of the chamber using an insulating collar 15.

The device uses a mains electricity supply between 100-240 volts, 50 or 60 Hz. Within the device a 12V DC supply is used for the control system and cooling fans and a 48V DC supply is used for generating the 0-500 watts radio frequency with a transistorised radio frequency amplifier 10.

In addition to the functions associated with this in invention, the controller 30 is more generally to monitor the safety of the system using signals from several additional sensors for the following parameters: temperature of radio frequency amplifier heat sink, door open, arc detector, smoke detector, power supply levels, reflected power, fan speeds. The controller responds in a safe manner when an adverse condition occurs and reports the problem on a touch screen display.

In practical terms it has been found that the following operating parameters produce good results:

switching from step 1 to step 2 after a period of time not exceeding 20 seconds, preferably not exceeding 15 seconds;

Within step 1 the parameters being from 2% to 6% of full power applied, up to 40 Watts reflected power, the rate of applied power increase is between 5 watts/second and 15 watts per second with the rate of change of capacitances as a percentage of the variable capacitances in the circuit is up to 20%.

Within step 2 the parameters being from 6% to 20% of full power applied, up to 15 watts limit on reflected power, rate of applied power increase is up to 200 watts per second and the rate of change of capacitances as a percentage of the variable capacitances in the circuit is up to 20%;

Within step 3 the parameters being from 20% to 100% of full power applied, up to 15 watts limit on reflected power, rate of applied power increase is up to 200 watts per second and the rate of change of capacitances as a percentage of the variable capacitances in the circuit is up to 5%.

Within step 4 the parameters are constant 100% of full power applied, up to 40 W limit on reflected power, and the rate of change of capacitances as a percentage of the variable capacitances in the circuit is up to 1%.

Variable value capacitors can be of rotary vane or vacuum types or may be solid state devices, including multiple capacitors of fixed values switched in and out of circuit by the controller 30 and solid state variable capacitors.

The foregoing is an illustrative example of the invention and is not limiting on the scope of the invention as encompassed by the claims.

1-19. (canceled)

20. A radio frequency heating system comprising:
a radio frequency amplifier configured to supply power to a radio frequency heating chamber;
a matching network comprising a controller configured to monitor forward and reflected power, phase and magnitude of the power supply to the heating chamber and to adjust the power supplied by the radio frequency amplifier and/or the impedance of the matching network in accordance with predetermined values of the reflected power, and/or phase and amplitude, and to prevent changes in the power output of the radio frequency amplifier if reflected power through the matching circuit exceeds the limit of the radio frequency amplifier or 50 watts whichever is the lesser.

21. The radio frequency heating system according to claim 20 wherein the matching network includes one or more variable capacitors.

22. The radio frequency heating system according to claim 21 in which the capacitance of the variable capacitors may be varied by the controller by up to 50% of their capacitance per second.

23. The radio frequency heating system according to claim 20 wherein the controller is configured to prevent changes in the power output of the radio frequency amplifier if reflected power through the matching circuit exceeds the limit of the radio frequency amplifier or 20 watts whichever is the lesser.

24. The radio frequency heating system according to claim 21 wherein the capacitance is varied by the controller by up to 10% of the variable capacitance per second.

25. The radio frequency heating system according to claim 20 in which control of power is applied to the heating chamber and the matching network is adjustable in four successive steps, comprising:
Step 1: applying 0% to 10% full power, with a rate of power increase of between 5 watts per second and 25 watts end second and a rate of change of the variable capacitances in the matching network of up to 50% of the variable capacitance per second and permitting up to 50 watts reflected power;
Step 2: applying between 5% to 50% of full operating power with a power increase of up to 500 Watts/second, permitting reflected power of up to 20 watts, and a rate of change of variable capacitances in the matching network of up to 50% of the variable capacitance per second;
Step 3 applying between 10% to 100% of full operating power with a power increase of up to 500 Watts/second, permitting up to 20 Watts reflected power, and a rate of change of variable capacitances in the matching network of up to 10% of the variable capacitance per second; and
Step 4 operating at constant power, permitting up to 50 W reflected power, and a rate of change of variable capacitances in the matching network of up to 10% of the variable capacitance per second.

26. The radio frequency heating system according to claim 25 in which power is applied under step 1 and/or step 2 for a predetermined time or until the power reaches a predetermined percentage of full power.

27. The radio frequency heating system according to claim 25 wherein the control of power moves from step 1 to step 2 after a period of time not exceeding 20 seconds.

28. The radio frequency heating system according to claim 25 in which the control of power moves from step 1 to step 2 after a period of time not exceeding 15 seconds.

29. The radio frequency heating system according to claim 25 in which power is applied under step 1 until the power output is 10% of full power; power is then supplied according to step 2 to until 20% of full power is reached, and then according to step 3 until full power is reached, and thereafter step 4 applies.

30. The radio frequency heating system according to claim 29 wherein in Step 1 2% to 6% of full power is applied with the rate of applied power increase is between 5 watts per second and 15 watts per second, up to 40 Watts reflected power is permitted and the rate of change of the variable capacitors is up to 20% of their capacitance.

31. The radio frequency heating system according claim 29 wherein in Step 2 6% to 20% of full power is applied with the rate of applied power increase is up to 200 watts per second, up to 15 Watts reflected power is permitted, and the rate of change of the variable capacitors is up to 20% of their capacitance.

32. The radio frequency heating system according to claim 29 wherein in Step 3 20 to 100% of full power is applied with the rate of applied power increase is up to 200 watts per second, up to 15 Watts reflected power is permitted and the rate of change of the variable capacitors is up to 20% of their capacitance.

33. The radio frequency heating system according to claim 29 wherein in Step 4 100% of full power applied, up to 40 W reflected power is permitted, and the rate of change of the variable capacitors is up to 1% of their capacitance.

34. The radio frequency heating system according to claim 20 having a power of 1500 watts or less.

35. The radio frequency heating system according claim 20 having a power of 1000 watts or less.

36. The radio frequency heating system according to claim 20 comprising a power meter configured to measure forward and reflected power and to pass said power measurements to the controller to adjust the forward power of the system.

37. The radio frequency heating system according to claim 20 comprising a phase and amplitude detector between the radio frequency amplifier and the heating chamber feeding phase and amplitude measurement to the controller which are used by the controller to vary the electrical impedance of the matching network.
